(19) United States
(12) Patent Application Publication
(10) Pub. No.: US 2018/0166790 A1
(43) Pub. Date: Jun. 14, 2018

(54) COMPOSITE FABRIC STRUCTURE FOR AVOIDING RADAR DETECTION

(71) Applicant: RICHARD CHI-HSUEH, SAN DIEGO, CA (US)

(72) Inventor: RICHARD CHI-HSUEH, SAN DIEGO, CA (US)

(21) Appl. No.: 15/828,735

(22) Filed: Dec. 1, 2017

Related U.S. Application Data
(60) Provisional application No. 62/432,703, filed on Dec. 12, 2016.

(51) Int. Cl. H01Q 17/00; D02G 3/44; D02G 3/38; B32B 5/02; B32B 27/04; B32B 27/12

(52) U.S. Cl. CPC H01Q 17/005; D02G 3/441; D02G 3/38; B32B 5/024; D10B 2401/18; B32B 27/12; B32B 2307/212; D10B 2101/20; D10B 2401/16; B32B 27/04

(57) ABSTRACT

A composite fabric structure for avoiding radar detection is disclosed. It mainly comprises a conductive fabric layer and a thermoplastic material layer, wherein the conductive fabric layer is formed by threads of a plurality of conductive spiral wires interlacing with threads of a plurality of non-conducting textile yarns and a plurality of metal wires, and wherein the conductive fabric layer is further coated with the thermoplastic material layer to form a composite fabric.

### REFERENCE TO RELATED APPLICATION

This Application is based on Provisional Application Ser. No. 62/432,703, filed 12 Dec. 2016, currently pending.

### BACKGROUND OF THE INVENTION

### 1. Field of the Invention

The present invention relates to a composite fabric structure for avoiding radar detection, especially to an anti-radar composite fabric which can absorb magnetic waves and has advantages of low weight, conductivity, fatigue resistance, corrosion resistance and the like.

### 2. Description of Related Art

With the development of technology, a large number of electric appliances, 3C products, as well as a variety of electromagnetic wave launchers, e.g. base stations and distribution lines, are indispensable and their electromagnetic waves can be found ubiquitously in our environment.

In the early days, people did not take notice of the effects of electromagnetic waves on human bodies. However, along with the increased incidence of various cancers, unknown diseases and the genetic variation of new species, scientists have come to realize the negative effects of electromagnetic waves on human bodies. Many studies show that hazards of electromagnetic radiation on health are serious and complicated. People who stay in an environment full of electrical appliances and electronic communications for a long period of time may be affected by electromagnetic interference.

Because use of electronic products are necessary to modern people, reducing the electromagnetic waves of the electronic products in the environment is a feasible way to avoid human bodies being exposed to the environment full of electromagnetic waves and any injuries to human bodies. Generally, the technique of eliminating electromagnetic waves depends mainly on an electromagnetic shielding effect. The so-called electromagnetic shielding effect refers to a condition that the electric field of the electromagnetic wave makes the electrons move in a metal when the electromagnetic wave enters the metal, so the electrons are redistributed to generate a new electric field until a newly generated electric field counteracts the electric field of the electromagnetic wave. In such a case, there is no electric field inside the metal, and the electromagnetic waves are eliminated. Accordingly, the electromagnetic interference (EMI) method for the electronic products usually adopts a conductive paint, a metal thin film, a textile having metal electroplating, or a conductive glue film. However, the paint and the electroplating are easily to peel off and thus the outside of the electronic products cannot be effectively protected anymore.

### SUMMARY OF THE INVENTION

In view of the above-mentioned problems, the object of the present invention is to provide a composite fabric structure for avoiding radar detection, especially to provide an anti-radar composite fabric which can absorb magnetic waves and has advantages of low weight, conductivity, fatigue resistance, corrosion resistance and the like.

Disclosed herein is a composite fabric structure for avoiding radar detection. It mainly comprises a conductive fabric layer and a thermoplastic material layer. The conductive fabric layer is formed by threads of a plurality of conductive spiral wires arranged in a second direction interlacing with threads of a plurality of non-conducting textile yarns and a plurality of metal wires all arranged in a first direction, and the conductive fabric layer is further coated with the thermoplastic material layer to form a composite fabric. Accordingly, the present invention has advantages of low weight, high strength, conductivity, anti-magnetic wave, fatigue resistance, corrosion resistance and can be used in the military industry for avoiding radar detection.

Specifically, the conductive fabric layer of the composite fabric structure for avoiding radar detection comprises a plurality of non-conducting textile yarns arranged in a first direction thereon, a plurality of metal wires arranged in a first direction on two sides of the plurality of non-conducting textile yarns, and a plurality of conductive spiral wires arranged in a second direction thereon. Each of the plurality of conductive spiral wires is formed by a non-conducting central yarn and a fine metal fiber wound around the non-conducting central yarn, and the plurality of metal wires are interlaced with the plurality of conductive spiral wires to form the conductive fabric layer having good conductivity.

According to an embodiment of the present invention, each of the plurality of metal wires has a diameter of 0.02-0.025 mm.

According to an embodiment of the present invention, the conductive fabric layer is further connected to a power supply unit for an output of DC, low voltage and low current and providing the conductive fabric layer to generate heat. The temperature of the power supply unit is adjustable, and preferably ranges from a room temperature of about 28° C. to 104° C.

According to an embodiment of the present invention, the thermoplastic material layer is selected from acrylonitrile resin.

Accordingly, the composite fabric structure as described above can be used in aviation industry, naval industry, automobile industry, construction and wind power generation, or used in military industries, e.g. shells of ships, submarines, fighters and the like, to avoid detection by radars.

According to the above description, in comparison with the traditional technique, a composite fabric structure for avoiding radar detection according to the present invention has the advantages as following:

1. The composite fabric of the present invention not only has a considerable low weight and a higher strength than a carbon fiber composite and a glass fiber composite, but also has effect of conductivity and resistance to electromagnetic waves.

2. The composite fabric of the present invention has advantages of fatigue resistance, corrosion resistance, a higher strength than steel, and lighter than aluminum in weight, which can be used in aviation industry, naval industry, automobile industry, construction and wind power generation.

3. The composite fabric of the present invention can be used in military industries, e.g. shells of ships, submarines, fighters and the like, to avoid detection by radars.

### BRIEF DESCRIPTION OF THE DRAWINGS

FIG. 1 is a schematic diagram showing a composite fabric structure for avoiding radar detection according to the present invention;

FIG. 2 is a cross-sectional view showing a composite fabric structure for avoiding radar detection according to the present invention;

FIG. 3 is a schematic diagram showing a conductive fabric layer having a plurality of non-conducting textile yarns, a plurality of metal wires and a plurality of conductive spiral wires according to the present invention;

FIG. 4 is a schematic diagram showing a composite fabric structure formed by a non-conducting textile yarn, a metal wire and a conductive spiral wire according to the present invention;

FIG. 5 is a schematic diagram showing a conductive fabric layer in an electrified state;

FIG. 6 is a schematic diagram showing a composite fabric in an electrified state.

### DETAILED DESCRIPTION OF THE PREFERRED EMBODIMENT

Hereinafter, an exemplary embodiment of the present invention will be described in detail with reference to the accompanying drawings.

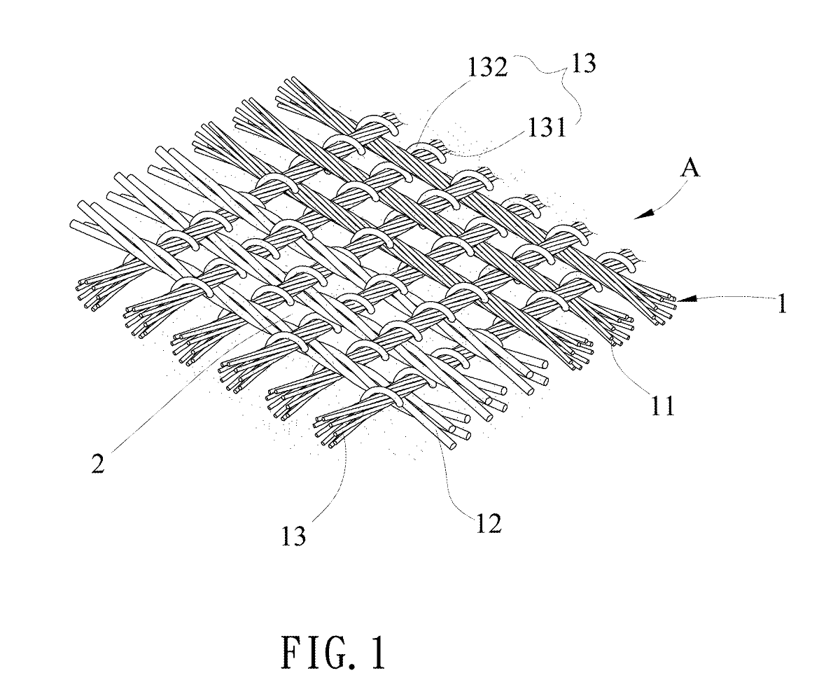

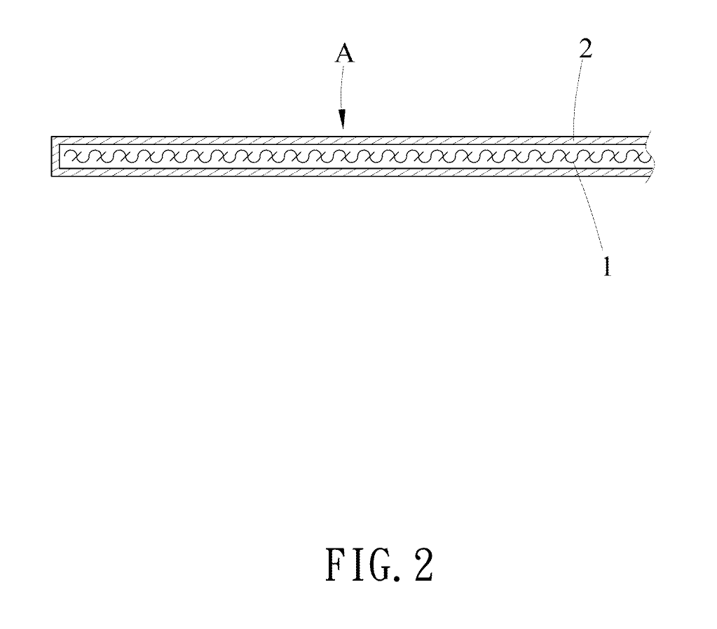

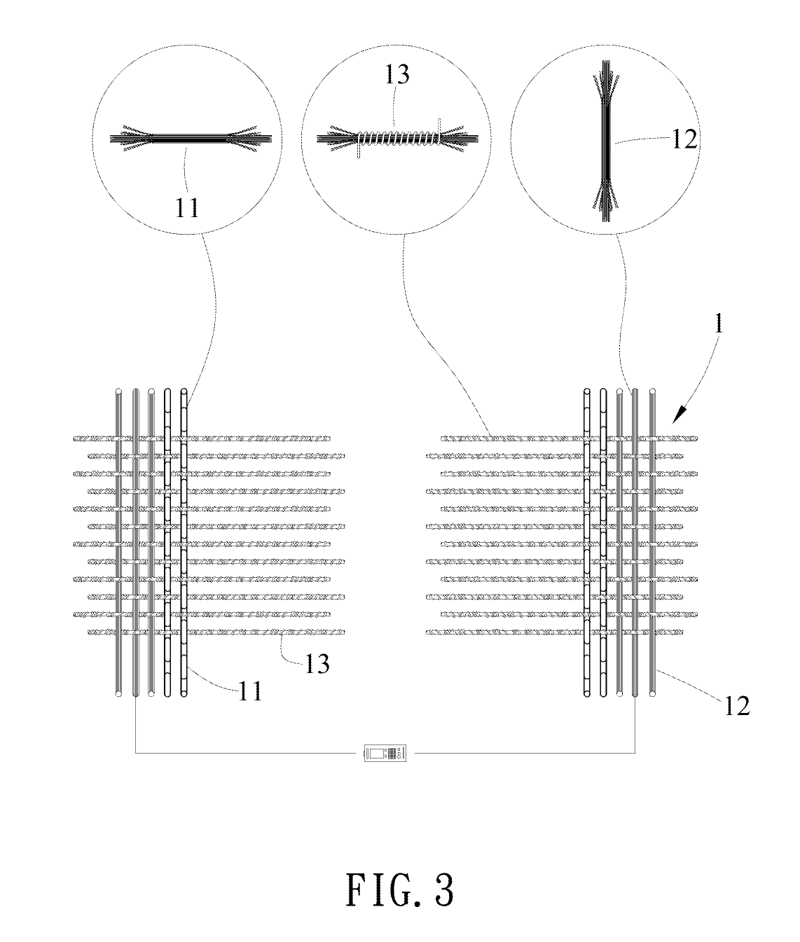

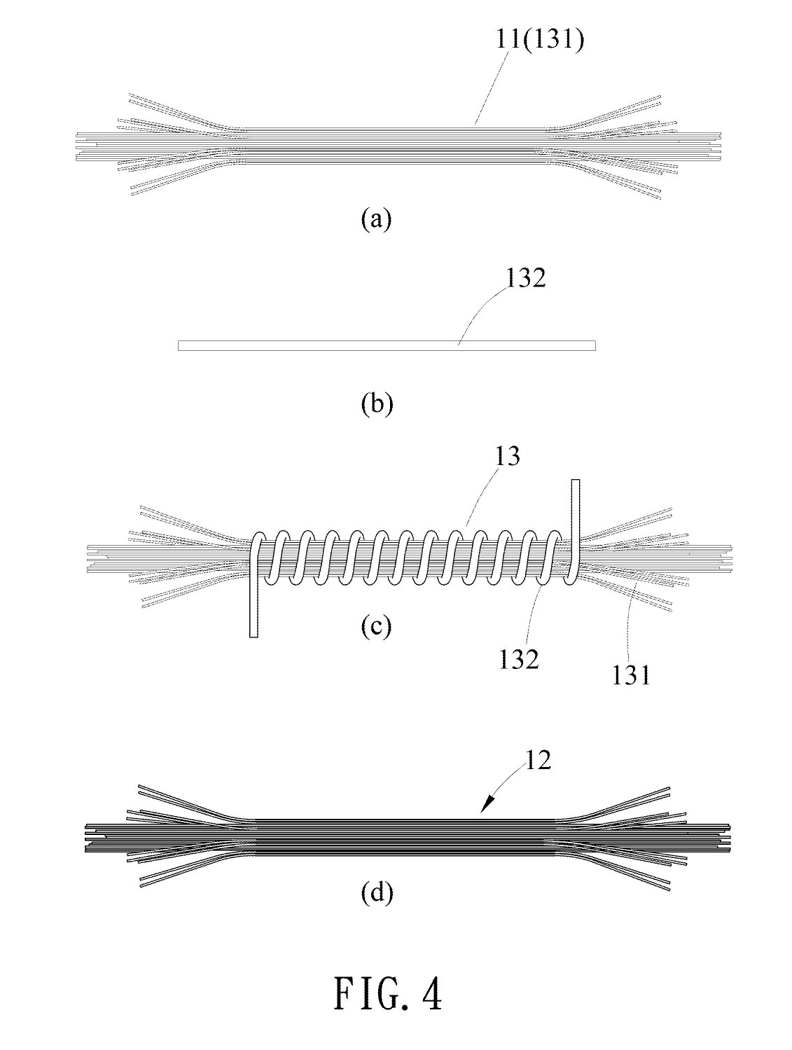

First, referring to FIG. 1 to FIG. 4, a composite fabric structure for avoiding radar detection according to the present invention comprises is disclosed. The composite fabric (A) mainly comprises:

a conductive fabric layer (1) having a plurality of non-conducting textile yarns (11) arranged in a first direction thereon, a plurality of metal wires (12) arranged in a first direction on two sides of the plurality of non-conducting textile yarns (11), and a plurality of conductive spiral wires (13) arranged in a second direction thereon, wherein each of the plurality of conductive spiral wires (13) is formed by a non-conducting central yarn (131) and a fine metal fiber (132) wound around the non-conducting central yarn (131), and wherein the fine metal fibers (132) of the plurality of metal wires (12) are interlaced with the plurality of conductive spiral wires (13); and

a thermoplastic material layer (2) for correspondingly wrapping up the conductive fabric layer (1).

According to the abovementioned description, the plurality of non-conducting textile yarns (11) and the non-conducting central yarns (131) can be made of the same material and be used as each other.

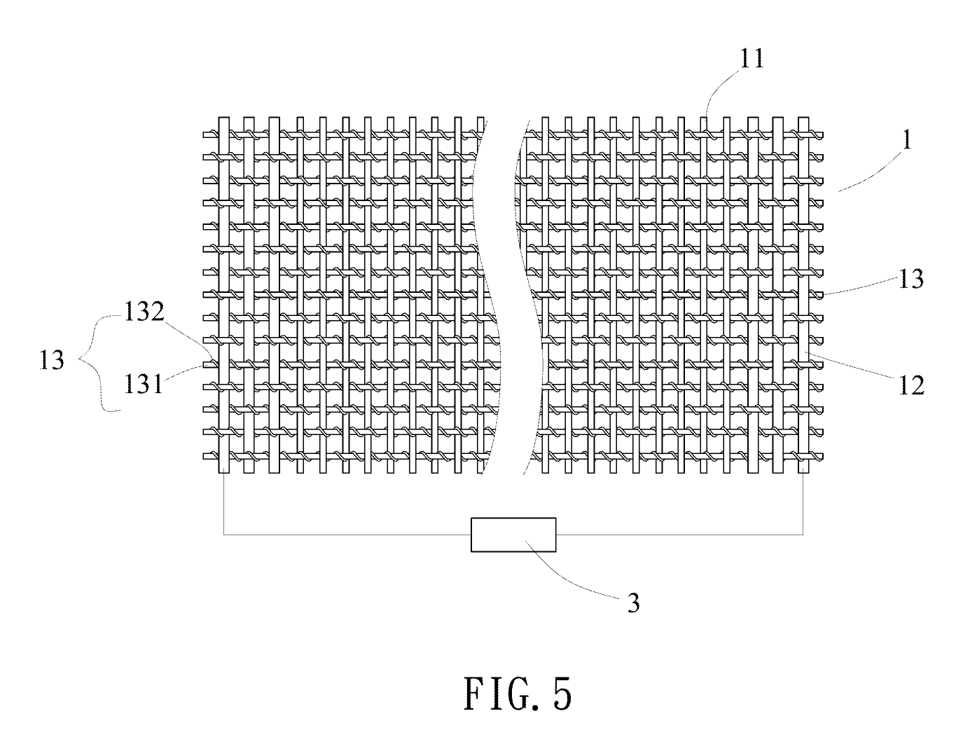

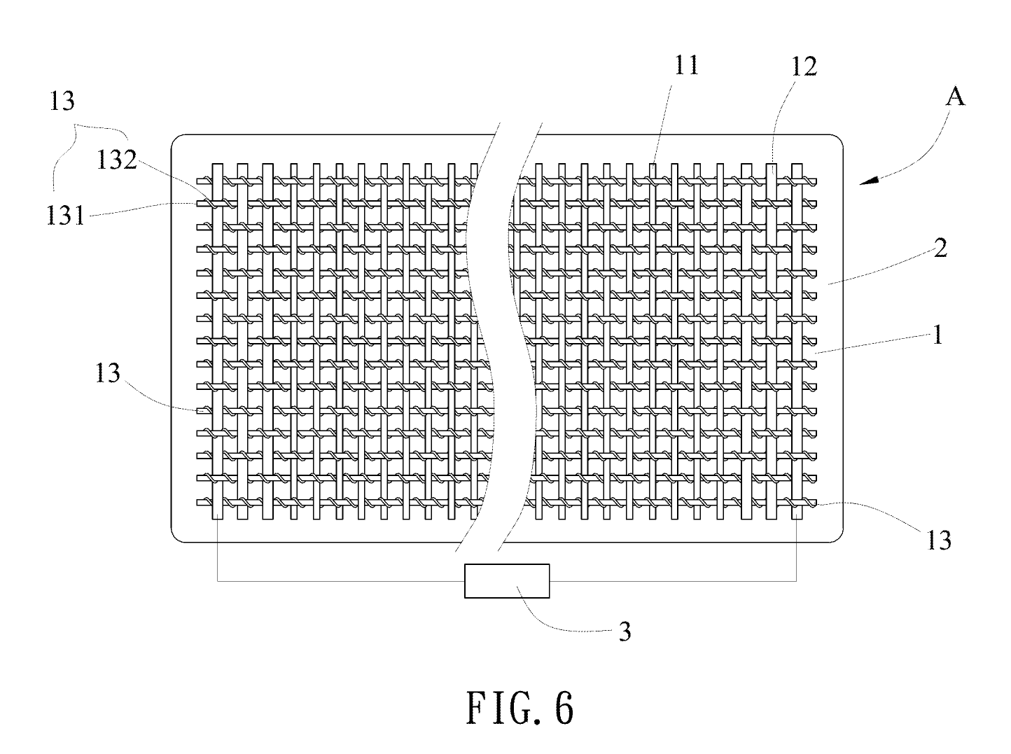

Referring to FIG. 1 to FIG. 6, in an actual production and use, the plurality of conductive spiral wires (13) are first formed by the plurality of non-conducting central yarns (131) and the plurality of fine metal fibers (132) wound around the plurality of non-conducting central yarns (131). Preferably, the plurality of non-conducting central yarns (131) are constituted by plural multi-core fibers. The plurality of fine metal fibers (132) are made of conductive metal filament, e.g. fine metal filaments of gold, silver, copper, and tungsten molybdenum, and each of the plurality of fine metal fibers (132) has a diameter of 0.02-0.025 mm. In manufacturing the conductive fabric layer (1), the plurality of non-conducting textile yarns (11) and the plurality of metal wires (12) are all arranged in the first direction, and the plurality of conductive spiral wires (13) are arranged in the second direction thereon. The plurality of metal wires (12) are further arranged in a width less than 1 cm from each of the two sides of the non-conducting textile yarn (11) on the conductive fabric layer (1). In such a case, the composite fabric (A) shaped with sheet, block or others can be prepared. After that, an external of the composite fabric (A) is further covered with the thermoplastic material layer (2). The thermoplastic material layer (2) is selected from acrylonitrile resin for covering externals of various wires of the composite fabric (A).

In weaving all kinds of fabric, the plurality of metal wires (12) are selected from plural fine copper wires or silver wires and further arranged in the first direction on the conductive fabric layer (1). The plurality of metal wires (12) are further arranged in a width less than 1 cm from each of the two sides of the non-conducting textile yarn (11) on the conductive fabric layer (1). A middle of the conductive fabric layer (1) is arranged with the plurality of non-conducting textile yarns (11) in the first direction. The plurality of conductive spiral wires (13) formed by the non-conducting central yarns (131) constituted by multi-core fibers and the fine metal fibers (132) wound around the non-conducting central yarns (131) are arranged in a second direction on the conductive fabric layer (1). In such a case, the plurality of conductive spiral wires (13) and the plurality of metal wires (12) are interlaced with each other to form a set of well conductive path. The plurality of metal wires (12) arranged on the two sides of the conductive fabric layer (1) are connected to a power supply unit (3) to generate heat, and a voltage (V), electric current (A), temperature (T), time and the like can be fine-adjusted by a computer. In such a case, the composite fabric (A) can be heated to the required temperature from a room temperature of about 28° C. to 104° C. Moreover, the thermoplastic material layer (2) further correspondingly wraps up the conductive fabric layer (1) for protection. Accordingly, the composite fabric (A) not only has a considerable low weight and a higher strength than a carbon fiber composite and a glass fiber composite, but also has effect of conductivity and resistance to electromagnetic waves. The advantages of fatigue resistance, corrosion resistance, a higher strength than steel, and lighter than aluminum in weight allow the composite fabric (A) to be used in aviation industry, naval industry, automobile industry, construction and wind power generation, or used in military industries, e.g. shells of ships, submarines, fighters and the like, to avoid detection by radars.

According to the above description, in comparison with the traditional technique, a composite fabric structure for avoiding radar detection according to the present invention has the advantages as following:

1. The composite fabric of the present invention not only has a considerable low weight and a higher strength than a carbon fiber composite and a glass fiber composite, but also has effect of conductivity and resistance to electromagnetic waves.

2. The composite fabric of the present invention has advantages of fatigue resistance, corrosion resistance, a higher strength than steel, and lighter than aluminum in weight, which can be used in aviation industry, naval industry, automobile industry, construction and wind power generation.

3. The composite fabric of the present invention can be used in military industries, e.g. shells of ships, submarines, fighters and the like, to avoid detection by radars.

What is claimed is:

1. A composite fabric structure for avoiding radar detection, comprising:
a conductive fabric layer having a plurality of non-conducting textile yarns arranged in a first direction thereon, a plurality of metal wires arranged in a first direction on two sides of the plurality of non-conducting textile yarns, and a plurality of conductive spiral wires arranged in a second direction thereon, wherein each of the plurality of conductive spiral wires is formed by a non-conducting central yarn and a fine metal fiber wound around the non-conducting central yarn, and wherein the plurality of metal wires are interlaced with the plurality of conductive spiral wires; and
a thermoplastic material layer for correspondingly wrapping up the conductive fabric layer.

2. As the composite fabric structure for avoiding radar detection claimed in claim 1, wherein the thermoplastic material layer is selected from acrylonitrile resin.

3. As the composite fabric structure for avoiding radar detection claimed in claim 1, wherein each of the plurality of metal wires has a diameter of 0.02-0.025 mm.

4. As the composite fabric structure for avoiding radar detection claimed in claim 2, wherein the conductive fabric layer is further connected to a power supply unit.

5. As the composite fabric structure for avoiding radar detection claimed in claim 3, wherein the plurality of metal wires are further arranged in a width less than 1 cm from each of the two sides of the non-conducting textile yarn.
